(19) United States
(12) Patent Application Publication
(10) Pub. No.: US 2024/0306607 A1
(43) Pub. Date: Sep. 19, 2024

(54) PET TREAT TOY

(71) Applicant: The Kyjen Company, LLC, Centennial, CO (US)

(72) Inventors: Danielle Salyer, Denver, CO (US); Nina Ingela Ottosson, Karlskoga (SE)

(21) Appl. No.: 18/607,108

(22) Filed: Mar. 15, 2024

Related U.S. Application Data
(60) Provisional application No. 63/452,986, filed on Mar. 17, 2023.

(51) Int. Cl. A01K 15/02; A01K 5/01

(52) U.S. Cl. CPC A01K 15/026; A01K 5/0114

(57) ABSTRACT

Provided is a pet toy including a body having a noisemaker and a plurality of appendages extending from the body. Each of the plurality of appendages includes a treat receptacle and is configured to be moved between a stowed arrangement and an extended arrangement. The treat receptacle included on each of the plurality of appendages may be inaccessible when a respective one of the plurality of appendages is in the stowed arrangement.

This application claims the benefit of priority to U.S. Provisional Application entitled “PET TREAT TOY” filed Mar. 17, 2023 and assigned Ser. No. 63/452,986, the entire disclosure of which is hereby expressly incorporated by reference.

### BACKGROUND OF THE DISCLOSURE

### Field of the Disclosure

The disclosure relates generally to pet toys, and more specifically, to interactive pet toys configured to mentally stimulate pets and engage pets for longer periods of time.

### Brief Description of Related Technology

Generally, a wide variety of pet toys are available to keep pets entertained. For example, pet toys including one or more of a squeaker, a bell, crinkle paper, and the like may be configured to make noise, entertaining pets. Other pet toys include balls, frisbees, wands, toys including treats (e.g., cat nip, pet treats), chew toys, and the like. Pets may quickly become disinterested in toys including treats, particularly, after they have obtained and enjoyed the treat included in the toy. Accordingly, there is a need for more interactive pet toys that engage pets for longer periods of time and provide a mental stimulus improving the overall health and behavior of pets.

### SUMMARY OF THE DISCLOSURE

In accordance with one aspect of the present disclosure, a pet toy includes a body and an appendage extending from the body. The appendage is configured to be moved between a stowed arrangement and an extended arrangement.

In accordance with another aspect of the present disclosure, a pet toy includes a body and a plurality of limbs extending from the body. Each of the plurality of limbs is configured to be moved between a stowed arrangement and an extended arrangement.

In accordance with yet another aspect of the present disclosure, a pet toy includes a body having a noisemaker and a plurality of appendages extending from the body. Each of the plurality of appendages includes a treat receptacle and is configured to be moved between a stowed arrangement and an extended arrangement.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a front view of a pet toy in accordance with one example of the present disclosure.

FIG. 2 illustrates a first side of an appendage of the pet toy of FIG. 1 in accordance with one example of the present disclosure.

FIG. 3 illustrates a second side of an appendage of the pet toy of FIG. 1 in accordance with one example of the present disclosure.

FIG. 4 illustrates another front view of the pet toy of FIG. 1 in accordance with one example of the present disclosure.

FIG. 5 illustrates a squeaker in accordance with one example of the present disclosure.

FIG. 6 illustrates a front view of another pet toy in accordance with one example of the present disclosure.

FIG. 7 illustrates another front view of the pet toy of FIG. 6 in accordance with one example of the present disclosure.

FIG. 8 illustrates a front view of another pet toy in accordance with one example of the present disclosure.

FIG. 9 illustrates another front view of the pet toy of FIG. 8 in accordance with one example of the present disclosure.

FIG. 10 illustrates an appendage of a pet toy in accordance with one example of the present disclosure.

FIG. 11 illustrates a second side of an appendage of a pet toy in accordance with one example of the present disclosure.

While the disclosed pet toys and methods are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

The present disclosure is provided to solve the above-mentioned problems in the Background of the Disclosure section. Specifically, the present disclosure provides a pet toy including a body and one or more appendages or legs extending from the body. Each of the appendages or legs may be independently movable between a stowed arrangement and an extended arrangement. Each of the appendages or legs may include one or more treat holders or receptacles, such as pockets or compartments, configured to hold (e.g., store) food (e.g., treats) for a pet. In accordance with some examples of the present disclosure, the treat receptacle(s) (e.g., pocket(s) or compartment(s)) included on an appendage or leg may be inaccessible when the appendage is in the stowed arrangement. Conversely, the treat receptacles may be accessible to a pet when the appendage is in the extended arrangement. Specifically, a pet may be able to remove a food or treat stored in the treat receptacle from the treat receptacle when the appendages are in the extended arrangement. Similarly, a person (e.g., pet owner) may be able to place food or treats in the treat receptacles when the appendages are in the extended arrangement (e.g., before subsequently moving the appendages to their stowed arrangements and giving the toy to a pet). In accordance with some examples, each of the plurality of appendages may be folded and/or rolled when they are in the stowed arrangement. According to some examples of the present disclosure, each of the appendages may be detachably coupled to itself when the appendage is in the stowed arrangement. For example, the appendage may be folded or rolled and opposite ends (e.g., a proximal end and a distal end) of the appendage may be detachably coupled to one another when the appendage is in the stowed arrangement. According to some examples of the present disclosure, each of the appendages may include a first (e.g., outer) side and a second (e.g., inner) side. The first side of the appendage may be comprised of a plush material and the second side of the appendage may be comprised of nylon. According to some examples of the present disclosure, the second side of the appendage may include a hook closure (i.e., a fastening implement including a plurality of hooks configured to latch onto loops included in a textile, fabric, or the like). According to some examples of the present disclosure, the hook closure may be detachably coupled to the first side of the appendage when the appendage is in the stowed arrangement. According to some examples, the first side of the appendage may be exposed or visible when the appendage is in the stowed arrangement. According to some examples, one or more treat receptacles may be disposed on the second side of the appendage. According to some examples, all of the treat receptacles included on an appendage may be disposed on the second side of the appendage. According to some examples, the body may include a noisemaker.

Although described herein in connection with a pet toy, the disclosed pet toy may also be used in various other applications. For example, the disclosed pet toy may be used as a toy for children (e.g., babies, toddlers).

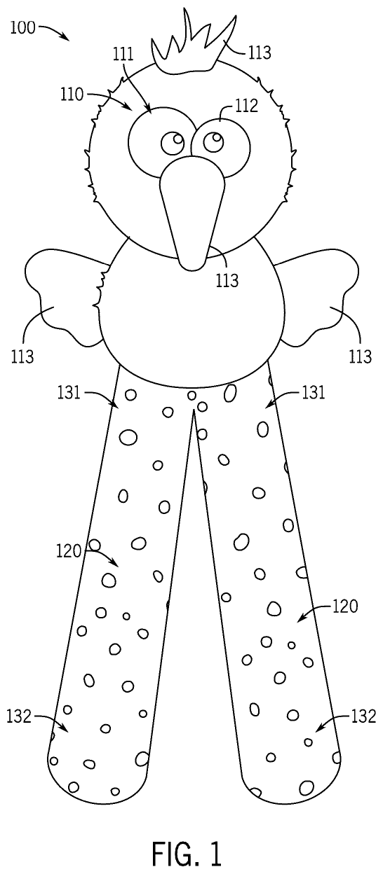

Referring to FIG. 1, a pet toy 100 is illustrated in accordance with one example of the present disclosure. As shown in FIG. 1, the pet toy 100 includes a body 110 and one or more legs or appendages 120. According to some examples, the body 110 (e.g., an exterior surface of the body 110) may be comprised of a plush textile. In some examples, the body 110 may be comprised of a plush textile having pile (e.g., a plurality of strands or loops) extending from a base textile. In some examples, the body 110 (e.g., exterior surface of the body 110) may be comprised of a polyester plush textile or fabric. According to some examples, the body may be stuffed, giving the body 110 a voluminous, three-dimensional shape.

The body 110 may have various shapes. In some examples, the body 110 may be shaped to represent on object or an animal. In some examples, the body 110 may be shaped to represent a portion of an animal (e.g., a portion excluding the limbs or legs of an animal) and the appendages 120 may be shaped to represent the limbs or legs of the animal. In this way, the body 110 and the appendages 120 are configured such that the pet toy 100 looks like, or has an appearance of, an animal, which may entice and elicit interaction with a pet. Specifically, the body 110 may have the shape of a flamingo, a giraffe, an octopus, or the like. The body 110 may have the shape of any item, object, or living thing. In some examples, the body 110 may further include one or more designs or images printed and/or embroidered on a surface of the body 110, some of which are discussed below. Additionally, the body 110 may have various sizes. For example, the body 110 may be a three-dimensional shape having a height, a width, and a depth each ranging from between one (1) inch and twenty-four (24) inches; however, the present disclosure is not limited thereto. According to some examples, the height, width, and depth of the body may each be between two (2) and ten (10) inches. In other examples, the sizes may be much larger.

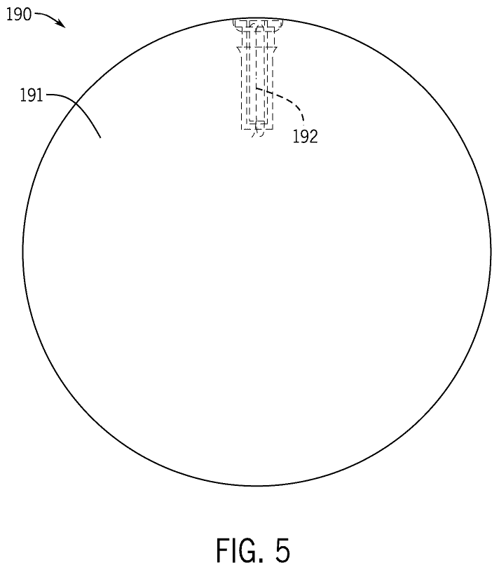

According to some examples, the body 110 may include a noisemaker (not shown in FIG. 1). The noisemaker may be disposed within the body 110. According to various examples of the present disclosure, the noisemaker may include a squeaker, a bell, crinkle paper, a rattle, a clicker, and the like. In some examples, the body 110 may include the squeaker 190 described below with respect to FIG. 5.

In some examples, as illustrated in FIG. 1, the body 110 may further include one or more decorative elements 111. The decorative elements 111 may be coupled to the body 110. Specifically, the one or more decorative elements 111 may be coupled or attached to an outer surface of the body 110. The decorative element 111 may be, for example, a design 112 printed or embroidered on the body 110. For example, a feature or features (e.g., eyes, nose, ears, mouth, eyebrows, or the like) of an animal represented by the body 110 may be printed or embroidered on the body 110. In other examples, the decorative element 111 may be one or more additional body parts or accessories 113 (e.g., wings, beak, ears, nose, hair, and the like) extending or protruding from the body 110.

The decorative elements may be sewn, glued, or otherwise coupled to the body 110. The decorative elements 111 may be comprised of a different material, have a different color, and/or have a different texture than the body 110. Specifically, in some examples, the body 110 and the decorative element 111 may have different textures, so as to attract a pet. Specifically, in some examples, a textile or fabric of which the body 110 is made and a textile or fabric of which the decorative element 111 is made may include pile or strands having different lengths. In other examples, the body 110 and the decorative element 111 may have contrasting colors, so as to attract a pet.

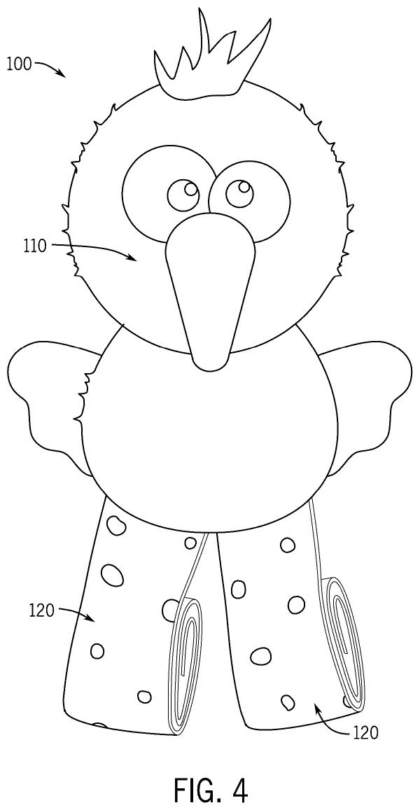

As shown in FIG. 1, the pet toy 100 further includes one or more (e.g., a plurality of) appendages 120. Each of the appendages 120 may extend from the body 110 and be movable between an extended arrangement (as illustrated in FIG. 1) and a stowed arrangement (as illustrated in FIG. 4). A size and shape of the appendages 120 may vary. According to some examples, as illustrated in FIG. 1, the appendages may have an elongate shape. The appendage 120 may be a three-dimensional shape having a height, a width, and a depth or thickness. According to some examples, the appendage 120 may have a height ranging between two (2) inches and twenty four (24) inches, a width ranging between half (0.5) an inch and four (4) inches, and a depth or thickness ranging between a tenth (0.1) of an inch and half (0.5) of an inch; however, the present disclosure is not limited thereto. According to some examples of the present disclosure, the one or more appendages 120 may be integrally formed with the body 110. According to other examples, the one or more appendages 120 may be formed separately from and subsequently coupled to the body 110. As illustrated in FIG. 1, each of the appendages 120 may include a proximal section or proximal end 131 adjacent or proximate to the body 110 and a distal section or distal end 132 opposite the proximal end 131.

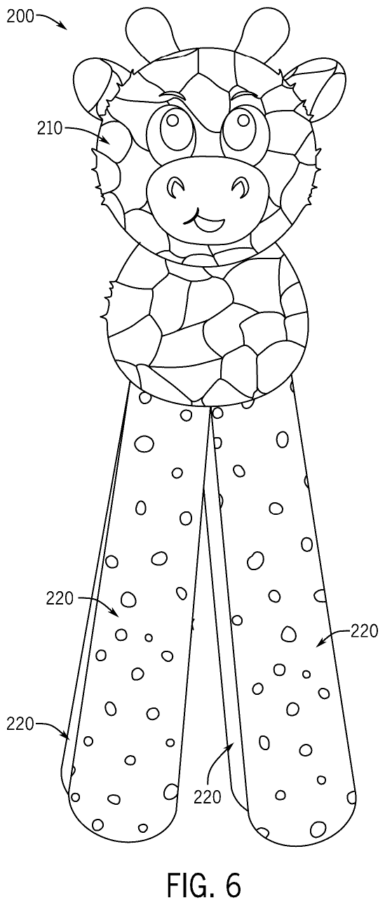

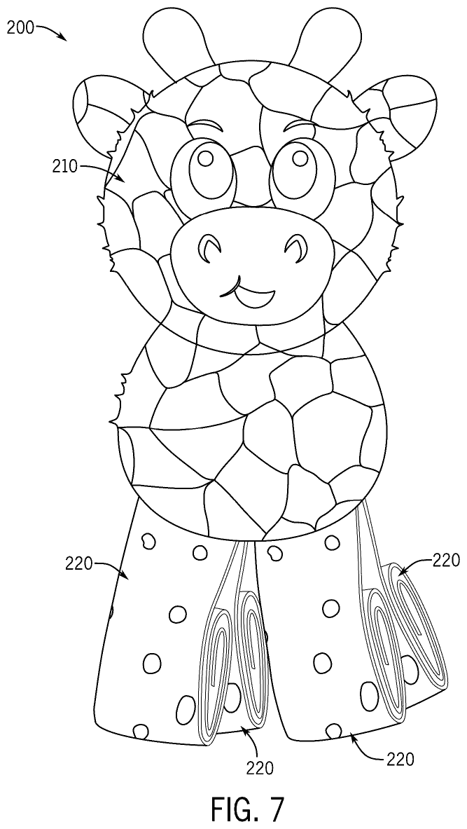

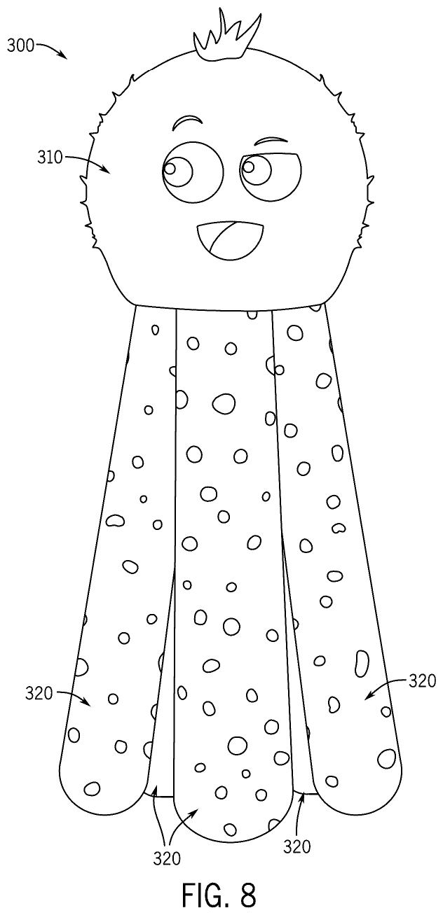

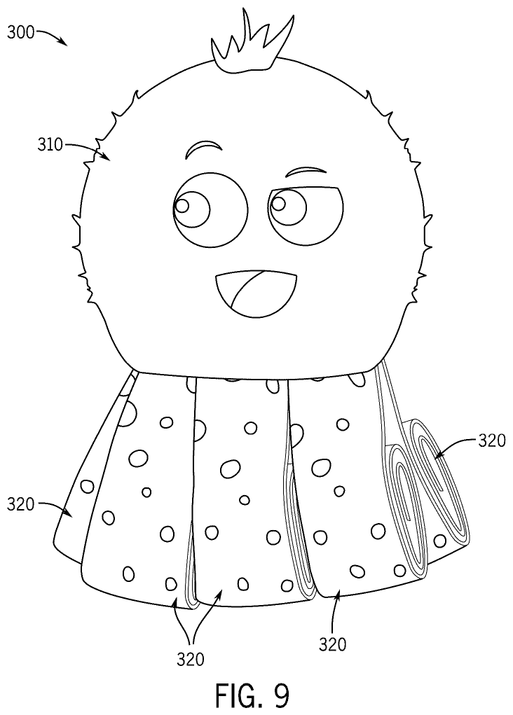

The pet toy 100 may include any number of appendages 120. In some examples, as illustrated in FIG. 1, the pet toy 100 may include two appendages 120. In other examples, the pet toy 100 may include four appendages 120 (as illustrated in FIGS. 6 and 7) or five appendages 120 (as illustrated in FIGS. 8 and 9). In other examples, the pet toy 100 may include a single appendage 120. According to some examples, the pet toy 100 may include a number of appendages corresponding to the number of limbs (e.g., legs, tentacles, etc.) that an animal represented by the body 110 has. According to some examples of the present disclosure, the body 110 and/or appendages 120 may include bright colors, distinct textures, and/or contrasting colors configured to attract the attention of a pet.

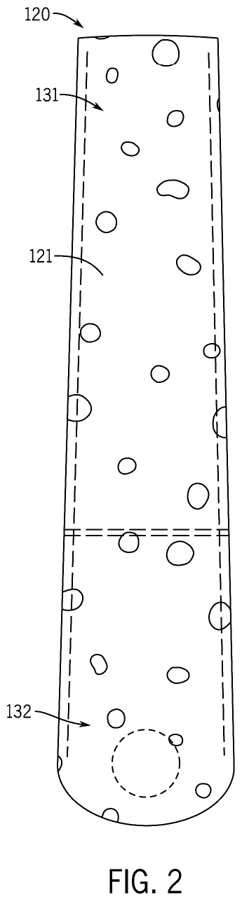

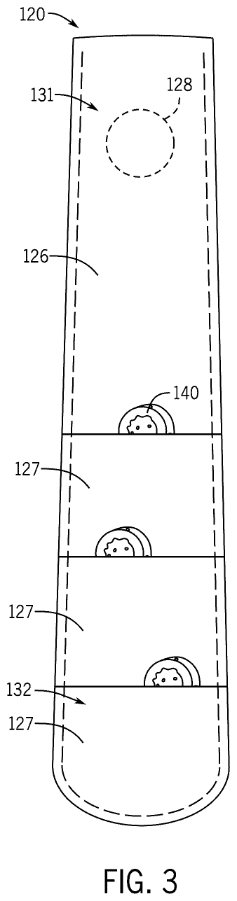

Referring generally to FIGS. 2 and 3, each appendage 120 may include a first side 121 (e.g., outer side) (as illustrated in FIG. 2) and a second side 126 (inner side) (as illustrated in FIG. 3). According to some examples, of the present disclosure, the first side 121 and the second side 126 of each appendage 120 may be comprised of a different material. According to some examples of the present disclosure, the first side 121 may be comprised of a plush textile. In some examples, the first side 121 may be comprised of the same plush textile as the body 110, but in other examples the textiles may be different. For example, the first side 121 may be comprised of a plush textile having pile (e.g., a plurality of strands or loops) extending from a base textile. According to some examples, the first side 121 may be comprised of a polyester plush textile or fabric. The plush textile or fabric may be different colors in order to form a pattern or design. In other examples, different portions of the first side 121 may include different types of plush textiles or fabric in order to form a pattern or design. According to some examples of the present disclosure, the second side 126 of each appendage 120 may be comprised of nylon. For example, the second side 126 may be comprised of a woven textile including 600 Denier (D) nylon fiber.

Referring to FIG. 3, a second side 126 of an appendage 120 of the pet toy 100 is illustrated in accordance with one example of the present disclosure. As illustrated in FIG. 3, the second side 126 may include one or more treat holders or receptacles, such as treat pockets 127. Each of the treat pockets 127 may include an additional piece of fabric or textile sewn or otherwise attached to the appendage 120 (e.g., a second side 126 of the appendage) along all but one side of the additional piece of fabric or textile thereby forming a sleeve or treat pocket 127, such that a treat or food 140 may be placed into or removed from the treat pocket 127. Each of the treat pockets 127 may be configured to store (e.g., hold) food or a treat 140 for a pet. Each of the treat pockets 127 may be accessible, such that a pet may remove a treat 140 from the treat pocket 127 and/or an owner my place food or a treat 140 in the treat pocket 127 when the appendage 120 is in the extended arrangement as illustrated in FIG. 3. Conversely, when the appendage 120 is in a stowed arrangement (as illustrated in FIG. 4) the treat pockets 127 included on the second side 126 may be inaccessible. Specifically, when the appendage 120 is in the stowed arrangement, a pet may be unable to remove a treat 140 from the treat pocket(s) 127 included on the second side 126.

The second side 126 may include any number of treat pockets 127. In some examples, the second side 126 may include a single treat pocket 127. In other examples, the second side may include two treat pockets 127, three treat pockets 127 (as illustrated in FIG. 3), four treat pockets 127, or more than four treat pockets 127.

Still referring to FIG. 3, in some examples, the second side 126 may further include a hook closure 128. The hook closure 128 may be a fastening implement or device including a plurality of hooks configured to latch on to loops (e.g., pile) included on a textile or fabric. In one example, the hook closure 128 may include a piece of Velcro®. According to some examples of the present disclosure, the hook closure 128 may be disposed at or near a proximal end 131 of the second side 126 of the appendage 120. According to some examples of the present disclosure, the hook closure 128 may be configured to detachably couple to the first side 121 of the appendage 120. Specifically, the hook closure 128 may be configured to latch on to the pile of the textile of fabric comprising the first side 121 (e.g., the outer surface of the first side 121). For example, the hook closure 128 may be configured to engage the pile of a synthetic plush textile or fabric comprising the first side 121 (e.g., the outer surface of the first side 121). According to the present disclosure, the hook closure 128 may be configured to maintain a position of the appendage 120 when the appendage 120 is in the stowed arrangement.

Specifically, the hook closure 128 included on the second side 126 may be detachably coupled to the first side 121 when the appendage 120 is in the stowed arrangement. Accordingly, a force exceeding a predetermined threshold (e.g., a coupling strength of the hook closure 128 and a textile comprising the second side 126) must be applied to the appendage 120 to move the appendage 120 from the stowed arrangement to the extended arrangement. While a hook closure 128 is described herein, other types of fastening implements or devices may be used. For instance, in one example, a snap fastener may be used, where one side or piece of the snap fastener is disposed at or near the proximal end 131 of the second side 126 (e.g., similar to where the hook closure 128 is located) and the other side or piece of the snap fastener is disposed at or near the mid-point (i.e., middle) of the outer surface of the first side 121, such that when the appendage 120 is rolled or folded into the stowed position, the two sides of the snap fastener align and can be coupled together. In another example, magnets may be used, where two attracting magnets are placed similarly to the snap fastener described above. The location of the fastening implements or devices may vary.

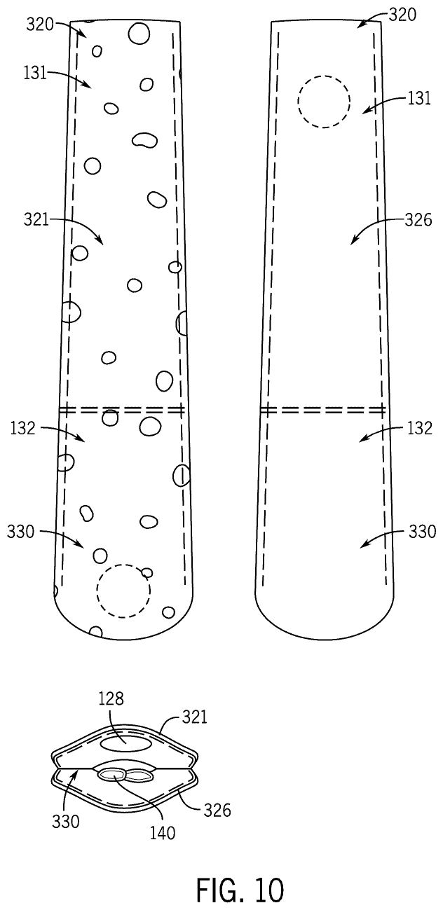

Although the treat pockets 127 described above are disposed on the inner, or second side 126, of the appendage 120, the disclosed pet toy 100 may also include additional treat pockets 127 located elsewhere on the pet toy 100, such as the body 110, on a decorative element 111 such as an additional body part or accessory 113, on the first side 121 of the appendage 120, or at/inside the distal tip of the appendage 120, as shown and described below with reference to FIG. 10.

According to some examples a first side 121 of each or all of the appendages 120 included in the pet toy 100 may include one or more pockets 127. In some examples, when a treat pocket 127 is included at or near the proximal end 131 of the first side 121 of the appendage 120, the treat pocket 127 may be accessible when the appendage 120 is in the stowed arrangement. In some examples, one or more treat pockets 127 included on the first side 121, at locations other than at or near the proximal end 121 of the first side 121, may be inaccessible when the appendage 120 is in the stowed arrangement.

Referring to FIG. 4, the pet toy 100 of FIG. 1 is illustrated in accordance with one example of the present disclosure. Specifically, FIG. 4 illustrates the pet toy 100 of FIG. 1, in a state in which all of the appendages 120 are in a stowed arrangement. As illustrated in FIG. 4, each of the appendages 120 may be folded and/or rolled over itself in the stowed arrangement.

According to some examples, the distal end 132 of the appendage 120 may be folded over an adjacent portion of the appendage 120, such that the treat pockets 127 are inside the fold. In other words, the appendage 120 is folded such that, for the first fold, the distal end portion of the second side 126 on one side of the fold contacts (i.e., is folded against) the adjacent portion of the second side 126 on the other side of the fold. The appendage 120 may be repeatedly folded over on itself in a similar fashion until the first side 121 of the appendage 120 contacts the hook closure 128 disposed on the second side 126 of the appendage 120. As the appendage 120 is folded, when the first side 121 contacts the hook closure 128 disposed on the second side 126, the hook closure 128 and the first side 121 may be pushed together (e.g., by a user) such that the hook closure 128 engages the pile of a textile comprising the first side 121 coupling the hook closure 128 to the first side 121 and maintaining the appendage 120 in the stowed arrangement. If the appendage 120 were to be folded in the opposite direction, such that the first side 121 is inside the folds, the treat pockets 127 would be on the outside of the folds and a risk of treats falling out of the treat pockets 127 may increase.

According to some examples, the distal end 132 of the appendage 120 may be rolled toward the proximal end 131 of the appendage 120 in a similar fashion as that described above for folding. For example, the appendage 120 may be continuously rolled over on itself (with the second side 126 being inside the roll) until the first side 121 of the appendage 120 contacts the hook closure 128 disposed on the second side 126 of the appendage. As the appendage 120 is rolled, when the first side 121 contacts the hook closure 128 disposed on the second side 126, the hook closure 128 and the first side 121 may be pushed together (e.g., by a user) such that the hook closure 128 engages the pile of a textile comprising the first side 121 coupling the hook closure 128 to the first side 121 and maintaining the appendage 120 in the stowed arrangement. While folding and rolling the appendages 120 are described herein, other types of manipulation of the appendages 120 may be used, such as twisting, bunching, and the like, in order to hide/conceal and show/reveal the treat pockets 127.

As shown in FIG. 4, each of the appendages 120 may be folded and/or rolled such that the second side 126 of each appendage 120 is hidden or concealed when the appendage 120 is in the stowed arrangement. Accordingly, the one or more treat pockets 127 included on the second side 126 of the appendage 120 may also be hidden or concealed when the appendage 120 is in the stowed arrangement. Specifically, the one or more treat pockets 127 may be inaccessible when the appendages 120 are in the stowed arrangement. Accordingly, a pet may not be able to access (and remove) food or a treat from a treat pocket 127 included on the second side 126 of the appendage 120 when the appendage 120 is in the stowed arrangement. Similarly, an owner may not be able to access the treat pocket 127 to place food or a treat in (e.g., fill) the treat pocket 127 when the appendage 120 is in the stowed arrangement.

As noted above, the hook closure 128 may detachably couple the second side 126 of the appendage 120 to the first side 121 of the appendage 120, such that, for example, the appendage 120 may be maintained in the stowed arrangement. The first side 121 and the second side 126 may be separated (e.g., detached) from one another in the stowed arrangement by pulling the first side 121 and the hook closure 128 on the second side 126 apart with a force exceeding a predetermined threshold corresponding to the coupling strength of the hook closure 128 and the fabric or textile comprising the second side 126. Accordingly, the hook closure 128 and the fabric or textile comprising the second side 126 may be configured to have a coupling strength that allows a pet and user to separate the first side 121 and the second side 126 of the appendage, for example, when the appendage 120 is in the stowed arrangement, such that the appendage 120 may be moved to the extended arrangement (and treats may be placed in or removed from the treat pockets 127 included on the second side 126). Once the first side 121 of the folded or rolled appendage 120 is pulled apart or detached from the hook closure 128, the appendage may be unfolded or unrolled back into the extended arrangement (i.e., hanging or laying freely).

Referring to FIG. 5, a squeaker 190 is illustrated in accordance with one example of the present disclosure. As noted above, according to some examples of the present disclosure the body 110 may further include a noisemaker. For example, the body 110 may include the squeaker 190 as the noisemaker. As illustrated in FIG. 5, the squeaker 190 may include a bladder 191 and a whistle 192. The bladder 191 may be configured to elastically deform and to hold a volume of air. In some examples, as shown in FIG. 5, the bladder 191 may have a round or circular shape. In other examples, the bladder 191 may have another shape. The whistle 192 may fluidly couple an interior of the bladder 191 to an exterior of the squeaker 190 such that air traveling into or out of the bladder 191 must travel through the whistle 192. The whistle 192 may include a vibrating component (e.g., reed) configured to produce or generate a noise as air flows through the whistle 192 (e.g., to or from the bladder 191). Accordingly, as air travels through the whistle 192 into and/or out of the bladder 191 the vibrating component may vibrate, generating a noise.

Accordingly, as a pet interacts or plays with the pet toy 100, the squeaker 190 included in the body 110 may be deformed (e.g., squeezed, compressed) and released, causing air to flow in and out of the bladder 191 and thus causing the whistle 192 to generate a noise. Although the squeaker 190 is described herein as being disposed in the body 110 of the pet toy 100, the squeaker 190 may be disposed in other areas of the pet toy 100 as well, such as the appendages 120 and/or additional body parts or accessories 113 (e.g., wings, beaks, ears, noses, and the like) extending or protruding from the body 110.

Referring generally to FIGS. 6 and 7, a pet toy 200 is illustrated in accordance with one example of the present disclosure. As shown in FIGS. 6 and 7, the pet toy 200 may include a body 210 and a plurality of legs or appendages 220. The body 210 may be the same as or substantially similar to the body 110 described above with respect to FIGS. 1 and 4 and the appendages 220 may be the same as or substantially similar to the appendages 120 described above with respect to FIGS. 1-4. For example, the body 210 may be comprised of a plush material and/or may include a noisemaker and the appendages 220 may include one or more treat pockets and hook closures, such as treat pockets 127 and the hook closure 128 described above.

In some examples, as illustrated in FIGS. 6 and 7, the pet toy 200 may include a body 210 having the shape of a giraffe, specifically, the body 210 may have the shape of a giraffe, without legs. Further, the pet toy 200 may include four legs or appendages 220 corresponding to the number of limbs (i.e., legs) that a giraffe has.

Referring generally to FIGS. 8 and 9, a pet toy 300 is illustrated in accordance with one example of the present disclosure. As shown in FIGS. 8 and 9, the pet toy 300 may include a body 310 and a plurality of legs or appendages 320. The body 310 may be the same as or substantially similar to the body 110 described above with respect to FIGS. 1 and 4 and the appendages 320 may be the same as or substantially similar to the appendages 120 described above with respect to FIGS. 1-4. For example, the body 310 may be comprised of a plush material and/or may include a noisemaker and the appendages 320 may include one or more treat pockets and hook closures, such as treat pockets 127 and the hook closure 128 described above.

In some examples, as illustrated in FIGS. 8 and 9, the pet toy 300 may include a body 310 having the shape of an octopus, specifically, the body 310 may have the shape of an octopus without tentacles. Further, the pet toy 300 may include five to eight appendages 320 corresponding to a larger number of limbs (e.g., tentacles) that an octopus has.

According to some examples, as illustrated in FIG. 10, a treat holder or receptacle, such as a treat compartment 330, may be included at a distal end 132 of each of the appendages 320. The appendages 320 may be the same or substantially similar to the appendages 120 described above. For example, a first side 321 and a second side 326 of the appendage 320 may be separated, providing access to a treat compartment 330 disposed between the first side 321 and the second side 326. In some examples, a hook closure 128 may be included on an inner surface of one of the first side 321 and the second side 326 and used to couple the first side 321 and the second side 326, closing the treat compartment 330, and thus, making the treat compartment 330 inaccessible. A pet or owner may separate the first side 321 and the second side 326, such that the treat compartment 330 is accessible. The treat compartment 330 at the distal end 132 of the appendages 320 of FIG. 10 may be in addition to other treat compartments or pockets disposed in the appendages 320. For example, the appendages 320 may include treat compartments along an inner surface (i.e., second side 326) of each appendage 320, similar to the treat pockets 127 described above, in addition to the treat compartment 330 at the distal end 132 of the appendages 320.

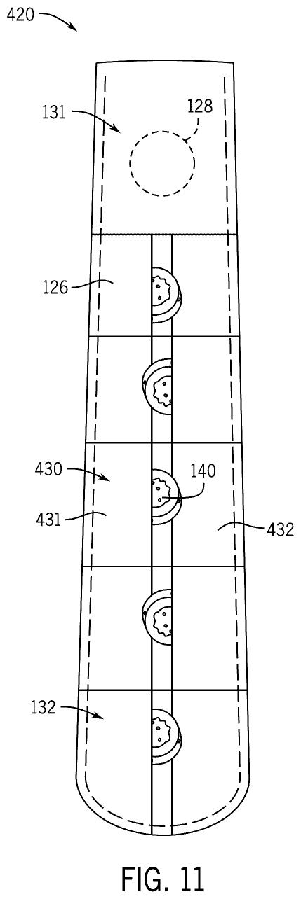

Referring to FIG. 11, a second side 126 of an appendage 420 for a pet toy is illustrated in accordance with one example of the present disclosure. The appendage 420 may be the same or substantially similar to the appendages 120 described above and may include one or more treat holders or receptacles. According to some examples, as illustrated in FIG. 11, a treat pocket 430 according to one example of the present disclosure may include a pocket first half 431 and a pocket second half 432. Each of the pocket first half 431 and the pocket second half 432 may include an additional piece of fabric or textile sewn or otherwise attached to the appendage 420 (e.g., second side 126 of the appendage 420) along all but one side of the additional piece of fabric or textile, thereby forming a sleeve configured to receive and hold food or a treat 140. According to some examples, as illustrated in FIG. 11, an open end or side (i.e., a side not sewn or otherwise attached to the appendage) of the pocket first half 431 and the pocket second half 432 may be disposed adjacent to one another and face one another. Specifically, as illustrated in FIG. 11, an open side of each of the pocket first half 431 and the pocket second half 432 may be a vertical side of the respective pocket half 431, 432 and may be disposed proximate to a vertical centerline of the appendage 420. Accordingly, in some examples, a treat 140 or food may be placed in either the pocket first half 431, the pocket second half 432, and/or between the pocket first half 431 and the pocket second half 432.

While the present disclosure has been described with reference to specific examples, which are intended to be illustrative only and not to be limiting of the disclosure, it should be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

What is claimed is:

1. A pet toy comprising:
a body; and
an appendage extending from the body, the appendage configured to be moved between a stowed arrangement and an extended arrangement.

2. The pet toy of claim 1, wherein a first side of the appendage is comprised of a plush material.

3. The pet toy of claim 2, wherein a second side of the appendage is comprised of nylon and includes a hook closure configured to detachably couple the second side of the appendage to the first side of the appendage.

4. The pet toy of claim 3, wherein in the stowed arrangement, the hook closure is coupled to the first side of the appendage.

5. The pet toy of claim 3, wherein the appendage includes a treat receptacle.

6. The pet toy of claim 5, wherein the treat receptacle is inaccessible when the appendage is in the stowed arrangement.

7. The pet toy of claim 5, wherein the treat receptacle is disposed on the second side of the appendage.

8. The pet toy of claim 1, wherein the body further comprises a noisemaker.

9. A pet toy comprising:
a body; and
a plurality of limbs extending from the body, each of plurality of limbs configured to be moved between a stowed arrangement and an extended arrangement.

10. The pet toy of claim 9, wherein each of the plurality of limbs include a plurality of treat receptacles.

11. The pet toy of claim 10, wherein each of the plurality of limbs includes a first side and a second side configured to be detachably coupled, the first side and the second side of one of the plurality of limbs being coupled when a respective one of the plurality of limbs is in the stowed arrangement.

12. The pet toy of claim 11, wherein each of the plurality of limbs further comprises a hook closure disposed on the second side, the hook closure configured to detachably couple the first side and the second side of a respective one of the plurality of limbs.

13. The pet toy of claim 11, wherein the plurality of treat receptacles included on each of the plurality of limbs are disposed on the second side of the plurality of limbs.

14. The pet toy of claim 11, wherein the first side is comprised of a plush material.

15. The pet toy of claim 10, wherein the plurality of treat receptacles included on each of the plurality of limbs are inaccessible when a respective limb of the plurality of limbs is in the stowed arrangement.

16. The pet toy of claim 9, wherein the body further comprises a noisemaker.

17. The pet toy of claim 9, wherein the plurality of limbs includes two limbs.

18. The pet toy of claim 9, wherein the body and the plurality of limbs are configured such that the pet toy has an appearance of an animal.

19. A pet toy comprising:
a body including a noisemaker; and
a plurality of appendages extending from the body, each of the plurality of appendages including a treat receptacle and configured to be moved between a stowed arrangement and an extended arrangement.

20. The pet toy of claim 19, wherein the treat receptacle included on each of the plurality of appendages is inaccessible when a respective one of the plurality of appendages is in the stowed arrangement.
